(19) United States
(12) Patent Application Publication
(10) Pub. No.: US 2026/0026475 A1
(43) Pub. Date: Jan. 29, 2026

(54) SYSTEM AND METHOD FOR DOG LEASH ATTACHMENT

(71) Applicant: Blair Doster, Dallas, TX (US)

(72) Inventor: Blair Doster, Dallas, TX (US)

(21) Appl. No.: 19/281,611

(22) Filed: Jul. 26, 2025

Related U.S. Application Data
(60) Provisional application No. 63/676,155, filed on Jul. 26, 2024.

(51) Int. Cl. A01K 27/00; F16M 13/02

(52) U.S. Cl. CPC A01K 27/004; A01K 27/008; F16M 13/022

(57) ABSTRACT

A leash attachment includes a housing, a first tether, a securing mechanism, a second tether, a first connector, and a second connector. The first tether includes a first end coupled to the housing. The securing mechanism is configured to removably couple a second end of the first tether to the housing. The second tether includes a first end retractably coupled to the housing. The first connector is coupled to a second end of the second tether. The second connector is coupled to the housing and configured to removably couple to the first connector.

### CROSS-REFERENCE TO RELATED APPLICATION AND PRIORITY CLAIM

This application claims priority under 35 U.S.C. § 119 (e) to U.S. Provisional Patent Application No. 63/676,155 filed on Jul. 26, 2024, which is hereby incorporated by reference in its entirety.

### TECHNICAL FIELD

This disclosure relates generally to dog leashes. More specifically, this disclosure relates to systems and methods for a dog leash attachment.

### BACKGROUND

The increasing popularity of dogs in urban population centers effectively requires pet owners to walk their pets in urban, public locations. Walking the dog is often the only exercise the pet and the owner are able to enjoy on a daily basis. The owner must carry a number of supplies during these walks to satisfy their needs as well as the needs of the dog, including the responsibility for the animal waste. Local ordinances often require that pet owners to walk their dogs on leashes and that pet owners pick up the solid waste left by their pets. In addition to the dog leash, pet owners typically carry other items, such as plastic waste disposal bags, keys, money, and pet supplies such as water and food while walking with their dogs. Pet owners typically use plastic bags to pick up the waste. Moreover, many owners would like to sit and talk with friends without constantly having to hold onto the dog leash. Many dog leashes include a clasp on one end to attached to a collar and a closed loop on the other end for the owner to hold onto. As shown in FIGS. 1 and 2, while closed loops can be slid over objects, that cannot be easily attached to an object, such as a light post, without unclasping the leash from the collar. For example, currently, a pet owner must unhook the dog leash from the dog collar, wrap the leash around an object; pull the leash through the handle; and re-hook the leash to the collar. These steps must then be repeated to unwrap the leash from the object. There is a need for a product due to the difficult and multi-step process currently required to attach a dog to various sized objects.

### SUMMARY

This disclosure provides systems and methods for a dog leash attachment.

In a first embodiment, an apparatus, such as a leash attachment, may include a housing, a first tether, a securing mechanism, a second tether, a first connector, and a second connector. The first tether may include a first end coupled to the housing. The securing mechanism may be configured to removably couple a second end of the first tether to the housing. The second tether may include a first end retractably coupled to the housing. The first connector may be coupled to a second end of the second tether. The second connector may be coupled to the housing and configured to removably couple to the first connector.

In a second embodiment, a method may include coupling a first end of a first tether to a housing. The method also may include removably coupling a second end of the first tether to the housing using a securing mechanism. The method may further include retractably coupling a first end of a second tether to the housing. In addition, the method may include removably couple a first connector arranged at a second end of the second tether to a second connector coupled to the housing.

In one of more of the previous embodiments, the apparatus may include a retraction mechanism positioned inside of the housing and coupled to the first end of the second tether.

In one of more of the previous embodiments, the apparatus may include an input positioned on the housing and configured to activate the retraction mechanism to retract the second tether.

In one of more of the previous embodiments, the input may be activated to allow the second tether to be extended

In one of more of the previous embodiments, the securing mechanism may be configured to secure the first tether to the housing at different lengths from the first end of the first tether.

In one of more of the previous embodiments, the first connector may be an I-bolt.

In one of more of the previous embodiments, the second connector may be a loop formed extending from the housing, and the I-bolt may connect to the loop.

In one of more of the previous embodiments, the apparatus may include an accessory arranged within the housing.

In one of more of the previous embodiments, the accessory may be a global position positioning system (GPS) tracker.

In one of more of the previous embodiments, the accessory may be a storage compartment to receive animal waste bags.

Other technical features may be readily apparent to one skilled in the art from the following figures, descriptions, and claims.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1 and 2 illustrate a prior art dog leash attached to a post;

FIGS. 3 through 8 illustrate a dog leash attachment according to this disclosure;

FIGS. 9A and 9B illustrate an example of a dog leash attachment according to this disclosure;

FIG. 10 illustrates example components of a dog leash attachment according to this disclosure;

FIGS. 11A and 11B illustrate example front and back views of a dog leash attachment according to this disclosure;

FIGS. 12A, 12B, and 12C are example right side, left side, and bottom views of a dog leash attachment according to this disclosure; and

FIG. 13 illustrates an example of a dog leash attachment according to this disclosure; and

FIGS. 14A-14D illustrate an example dog leash attachment according to this disclosure; and

FIG. 15 illustrates an example method for using a dog leash attachment according to this disclosure.

### DETAILED DESCRIPTION

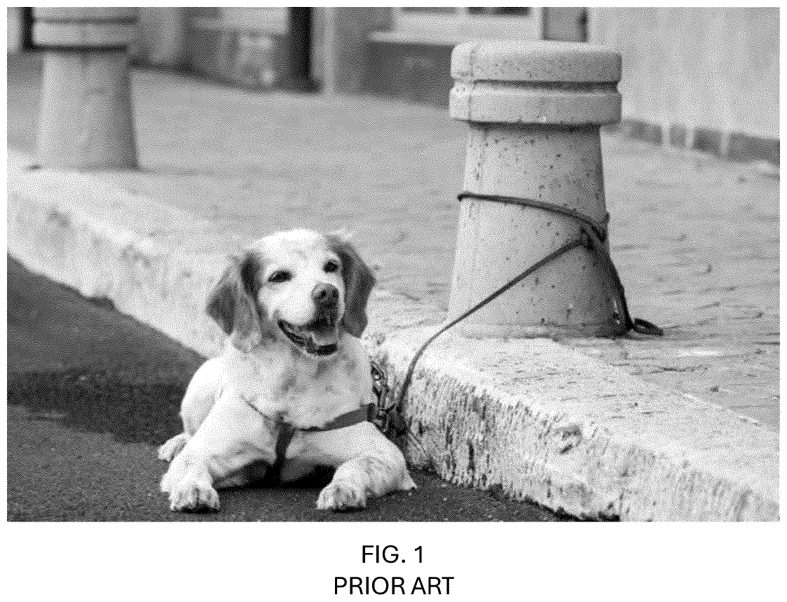

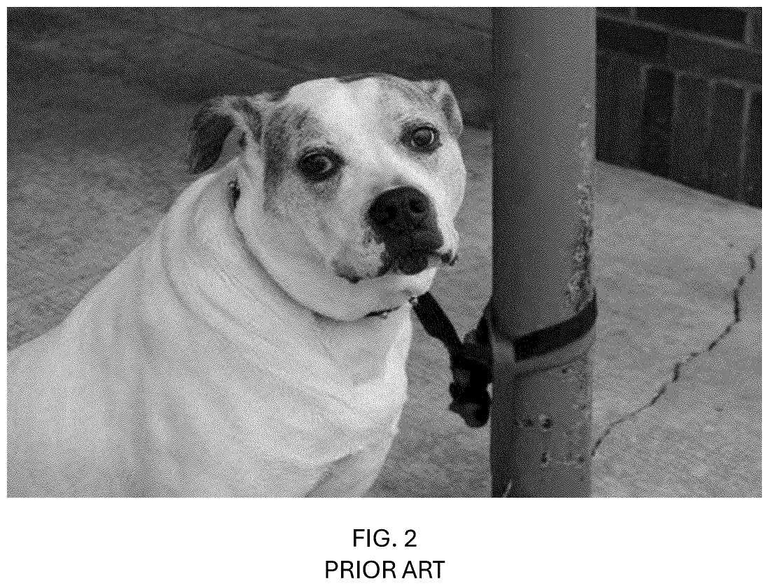

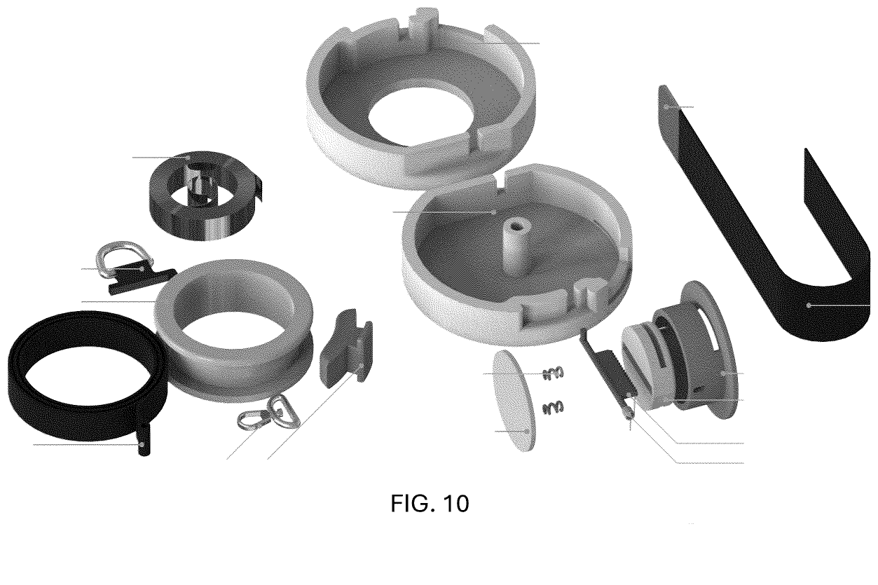

FIGS. 1 through 15, described below, and the various embodiments used to describe the principles of the present disclosure are by way of illustration only and should not be construed in any way to limit the scope of the disclosure. Those skilled in the art will understand that the principles of the present disclosure may be implemented in any type of suitably arranged device or system.

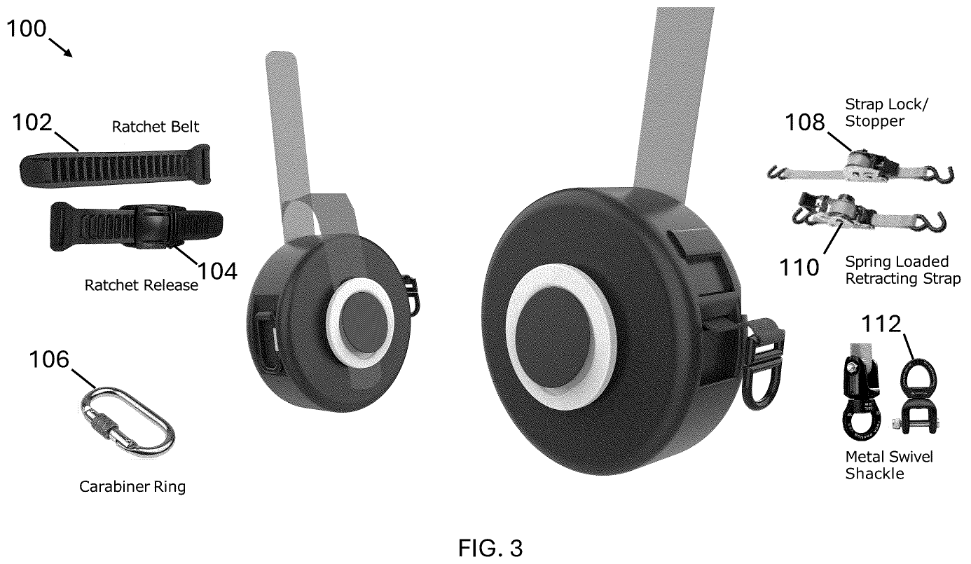

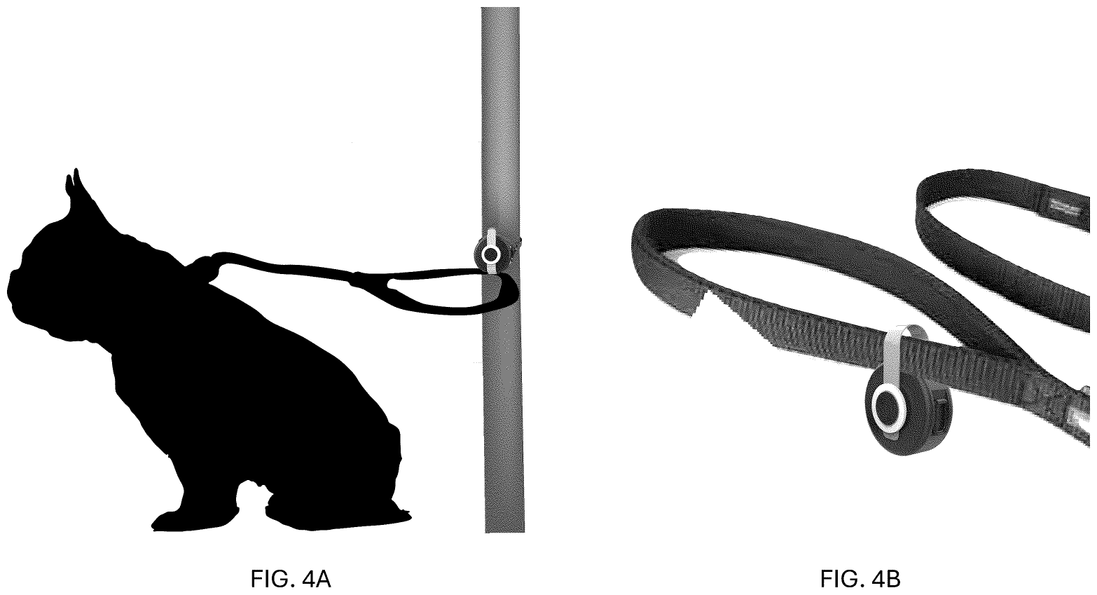

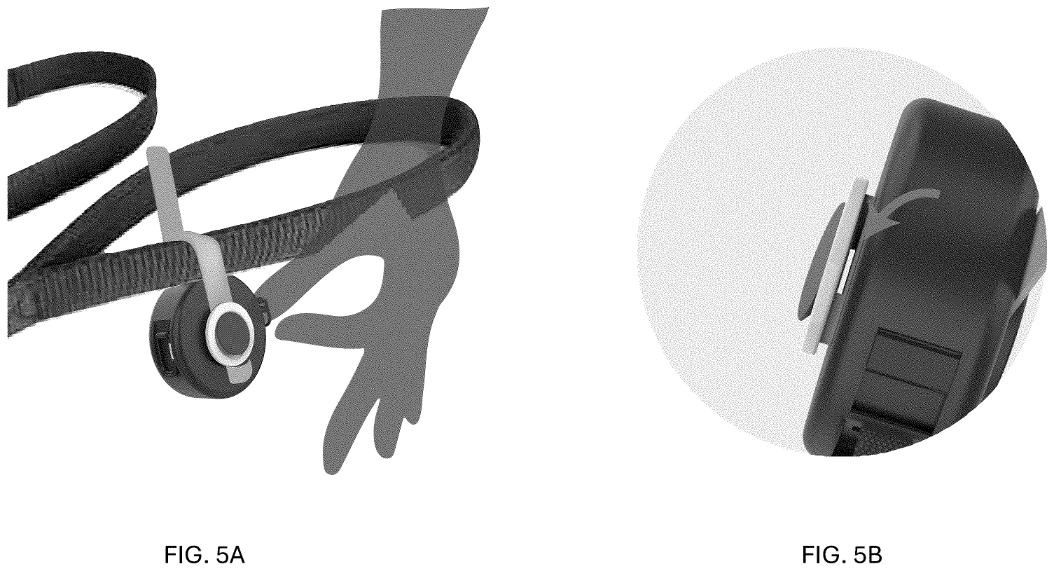

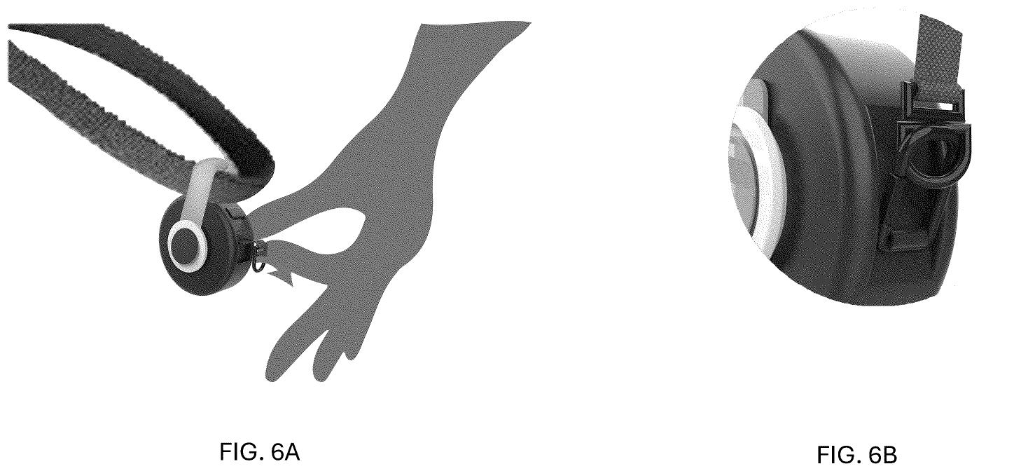

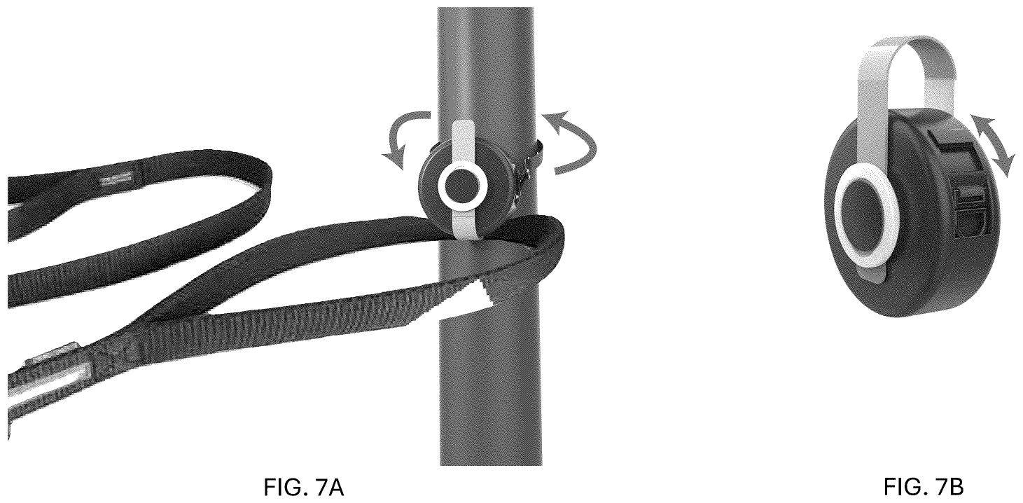

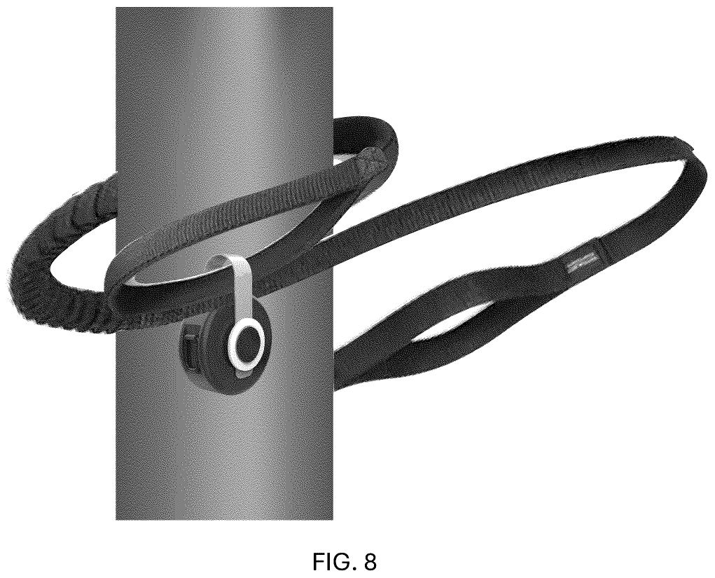

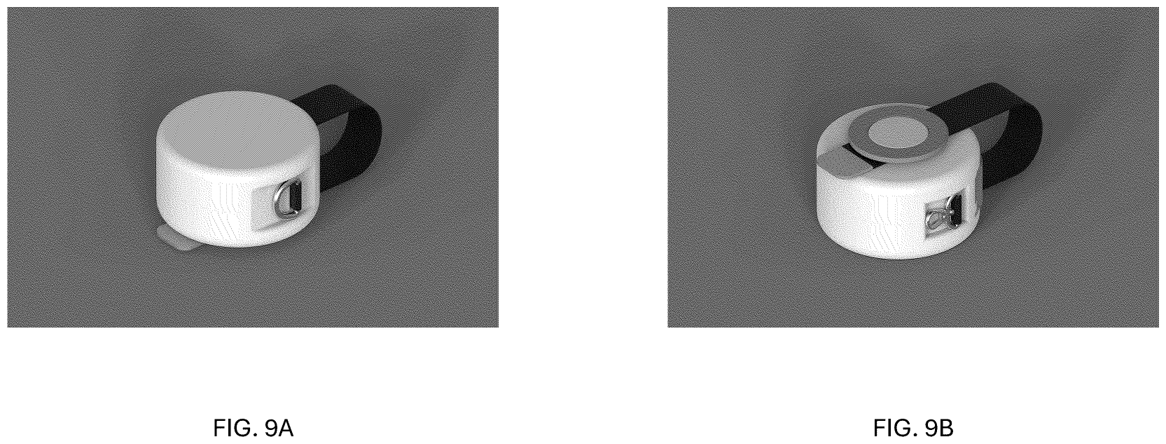

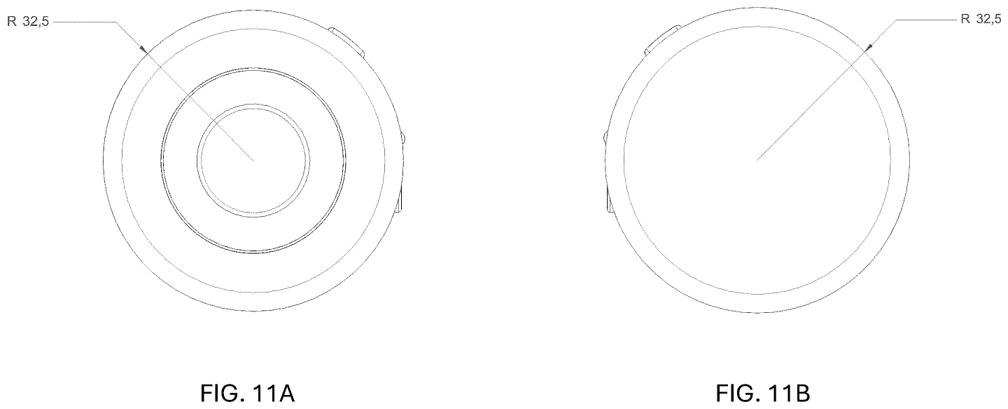

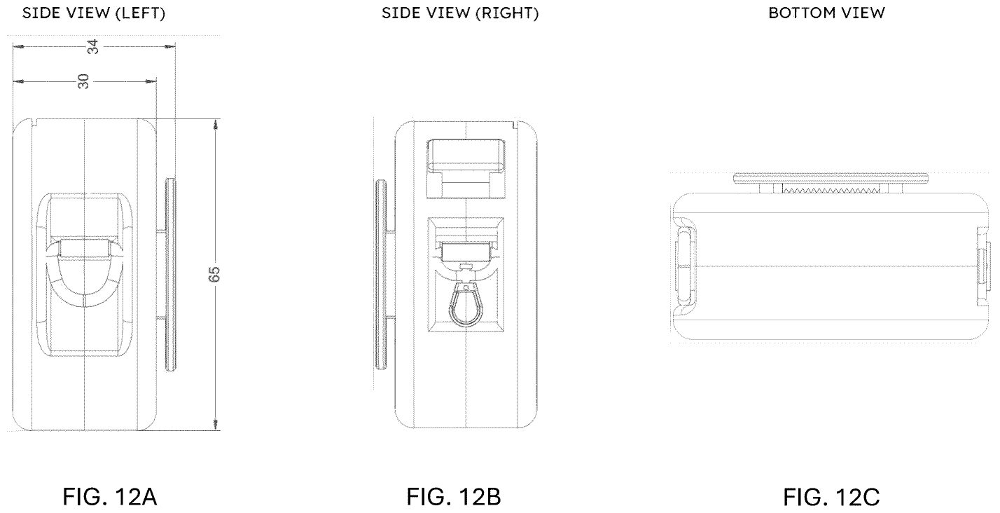

The present disclosure comprises a system and method for attaching a pet to objects such as, table, chairs, poles, bike racks, etc. Referring now to FIG. 3, an embodiment of a dog leash attachment 100 is shown having a ratchet belt 102, a ratchet release 104, a carabiner ring 106, a strap lock/stopper 108, a spring-loaded retracting strap 110, and a metal swivel shackle 112. Referring now to FIG. 4, the dog leash attachment 100 may be removably attached to a dog leash and used to secure the leash to an object. Referring now to FIG. 5, dog leash attachment 100 may be secured to a dog leash by wrapping a ratchet belt around the leash and inserting it into the stopper. Referring now to FIGS. 6 and 7, dog leash attachment 100 may be secured to an object by pulling out a spring-loaded retractable strap, wrapping it around an object, and connecting a loop on the strap to a connector located on the device. In various embodiments, the dog leash attachment 100 may include a stopper that, when activated, will prevent the strap from being pulled out or retracting back into the device. To unsecure the leash from the object, the strap is disconnected from the device and the strap retracted back into the device. Referring now to FIG. 8, in some embodiments, the ratchet belt may be used to secure a leash to an object without needing to unhook the dog from the leash by, for example, wrapping the leash around the object and wrapping the ratchet belt around the leash and a handle of the leash and securing the ratchet belt to the device. Referring now to FIGS. 9A and 9B, the dog leash attachment may come in various shapes, sizes, and colors. Referring now to FIG. 11, the component parts of an embodiment of a dog leash attachment are shown, including a base having a front and a back, a first and second strap, a ratchet mechanism, one or more springs, and one or more clasps. Referring now to FIGS. 11A, 11B, 12A, 12B, and 12C, various views of an embodiment of a dog leash attachment are shown.

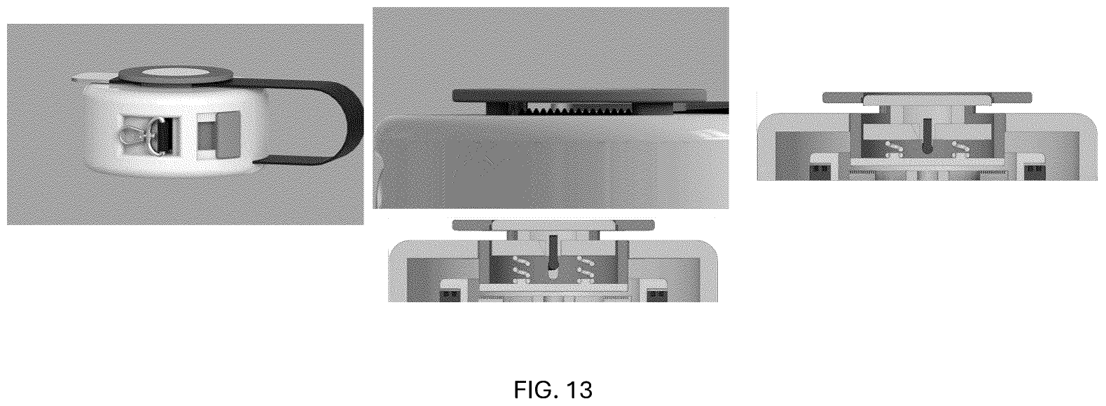

Referring now to FIG. 13, various aspects of an embodiment of a dog leash attachment 100 are shown. To use the retractable strap, a user pulls the clasp, similar to a tape measure, which retracts with the help of a spring, and may be locked in place with the help of a slider. To use the belt, which may be made of nylon, to attach the dog leash attachment to a leash, the belt is slid through a toothed piece allowing it to be slid in easily but locked when pulled in the other direction. To remove the belt, a button is depressed to move the toothed piece away from the belt, allowing the belt to slide freely.

In some embodiments, the dog leash attachment may be attached to different leash types and sizes, including a rope leash with loop handle, a retractable dog leash, and others. In various embodiments, the retractable strap may fit around large objects, for example, up to 10 inches in diameter or larger. In various embodiments, the retractable strap may be lockable such that pulling on the leash will not pull-out additional length of the strap.

Although FIGS. 3 through 13 illustrate a dog leash attachment, various changes may be made to FIGS. 3 through 13. For example, the sizes, shapes, and dimensions of the dog leash attachment 100 and its components can vary as needed or desired. Also, the number and placement of various components of the dog leash attachment 100 can vary as needed or desired. In addition, the dog leash attachment 100 may be used in any other suitable process and is not limited to the specific processes described above.

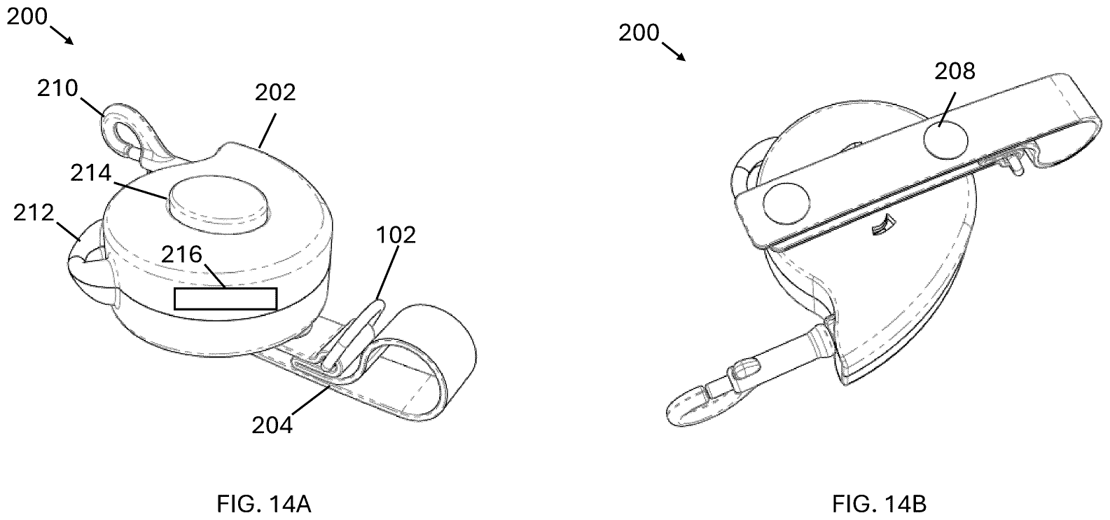

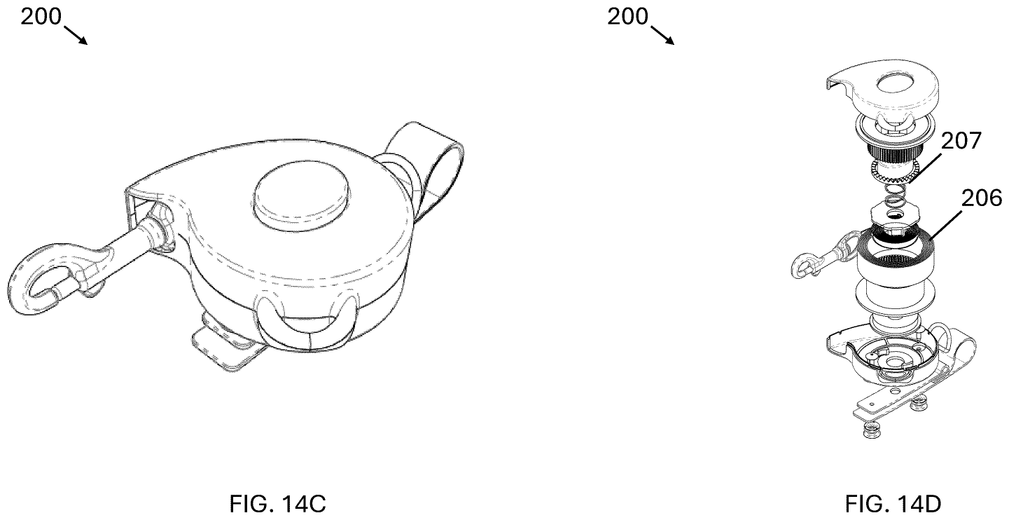

FIGS. 14A through 14D illustrate a leash attachment 200 in accordance with this disclosure. The embodiments of the leash attachment 200 illustrated in FIGS. 14A through 14D are for illustration only. FIGS. 14A through 14D do not limit the scope of this disclosure to any particular implementation of a leash attachment.

As shown in FIGS. 14A through 14D, leash attachment 200 includes a housing 202 configured to support and organize various components of the attachment. The housing 202 can be made from a sturdy material, such as plastic, metal or any other suitable material for storing the components of the leash attachment 200.

Disposed within or supported by the housing 202 is a first tether 204 and a second tether 206, each can be independently extendable and retractable to allow controlled freedom of movement for attached subjects, such as pets. The tethers 204 and 206 can be operatively coupled to a retraction mechanism 207, which may include a spool, reel, ratchet, or locking element to selectively engage or release the tethers, thereby preventing or permitting tether extension. In certain embodiments, at least one of the first and second tethers 204 and 206 can have a fixed length and statically extend from the housing 202. In certain embodiments, the second tether 206 is extendable when the input is continuously activated.

The first tether 204 having a proximal end secured within or to the housing 202 and a distal or second end terminating in a securing mechanism 208. The securing mechanism 208 is configured to removably couple the second end of the first tether 204 to the housing 202, thereby allowing the tether to be selectively attached or detached from the housing as needed. In one embodiment, the securing mechanism 208 comprises a clasp, latch, snap-fit connector, magnetic coupling, or mechanical locking interface that mates with a corresponding receiving structure on the housing 202. When engaged, the securing mechanism 208 maintains the first tether 204 in a fixed, closed-loop configuration with the housing, suitable for forming a handle, restraint loop, or temporary anchor point. When disengaged, the second end of the first tether 204 is released, allowing for reconfiguration, extension, or alternative use of the first tether 204. The securing mechanism 208 may include a manually actuated release, such as a push-button, slider, or twist-lock, that permits easy operation with one hand. The structure is designed to withstand tensile loads commonly encountered during leash use, while also providing rapid, reliable detachment when desired. This configuration enhances versatility of the leash attachment 200, enabling multiple modes of use including tethering to fixed objects, quick-release handling, or modular attachment to other components or accessories. The securing mechanism 208 can be used to adjust a size of the loop created by the first tether or couple the first tether at different lengths to the housing 202.

The second tether 206 having a first end coupled to the housing 202 and a second end terminating in a first connector 210. The first connector 210 is configured to engage with a second connector 212 that is fixedly attached to the housing 202. For example, the first connector 210 can be a latch, I-bolt, or any other suitable connector. The second connector 212 may be integrally formed with or rigidly mounted to an external surface or recessed docking feature of the housing. The first connector 210 and second connector 212 are mechanically and/or magnetically complementary and configured to releasably interlock with one another to form a secure connection between the distal end of the second tether 206 and the housing 202. In one embodiment, the connectors 210 and 212 comprise a snap-fit buckle, carabiner and loop, threaded coupling, bayonet fitting, or magnetic latch with mechanical backup, allowing for quick and reliable engagement and disengagement. This coupling enables the user to selectively attach the second tether 206 back to the housing 202 when in use, to create a closed-loop configuration, or to secure the leash attachment around an object such as a post, belt loop, backpack strap, table post, chair leg, or any other suitable anchor point. The connection formed between the first connector 210 and second connector 212 is designed to resist accidental release under tension while still permitting intentional disconnection by the user. The materials used for the connectors may include metal, polymer, or composite materials with high tensile strength and wear resistance suitable for repeated use in outdoor environments. This configuration provides flexibility and utility in both stowed and deployed modes of the leash attachment 200.

The leash attachment 200 includes an input 214 configured to initiate retraction of the second tether 206. The input 214 may be implemented as a mechanical button, sliding switch, touch sensor, or wireless receiver, and is operatively coupled to a retraction mechanism 207 housed within the housing 202. Upon actuation of the input 214, the retraction mechanism 207 is triggered to retract the second tether 206, drawing the first connector 210 back toward the housing 202 in a controlled manner. In certain embodiments, the input 214 is also configured to control the retraction of the first tether 204, either sequentially or simultaneously with the second tether 206. In such configurations, the input 214 may include multiple operational modes, such as a multi-position switch or programmable controller, or may work in conjunction with an additional input (e.g., a second button or paired wireless control) to independently or jointly retract the first and second tethers 204 and 206. The input system may include visual or tactile indicators to confirm activation, and may be powered by a battery or capacitor located within the housing 202. This configuration allows for flexible user control, enabling selective tether management based on the desired operational context or user preference.

Additionally, the housing 202 supports an accessory 216, which may include but is not limited to a flashlight, speaker, global positioning system (GPS) tracker, storage compartment, or other functional enhancement configured to aid the user or pet. Each of the components of leash attachment 200 is mechanically and/or electronically integrated to function in concert, and the overall design allows for ergonomic handling by a user during use. The device may be fabricated from durable, lightweight materials such as polymer, aluminum alloy, or composites suitable for outdoor conditions.

Although FIGS. 14A through 14D illustrate a leash attachment 200, various changes may be made to FIGS. 14A through 14D. For example, the number and placement of various components of the leash attachment 200 can vary as needed or desired. In addition, the leash attachment may be used in any other suitable process and is not limited to the specific processes described above.

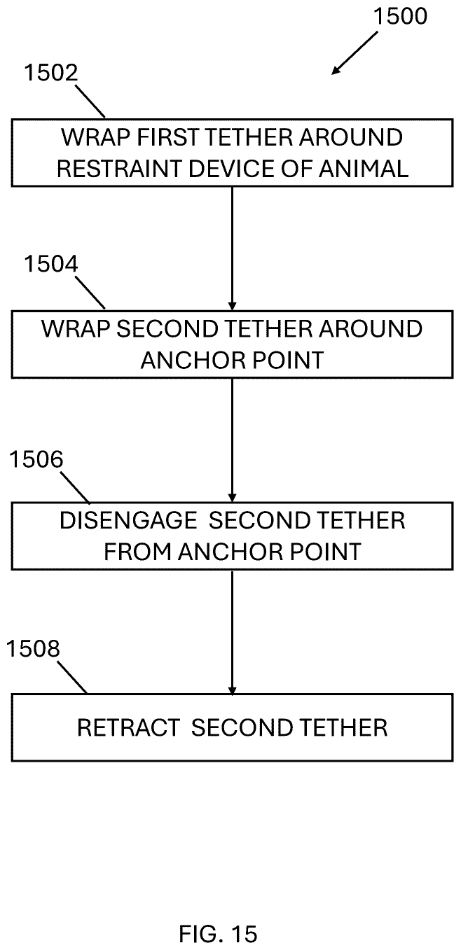

FIG. 15 illustrates an example method 1500 for operating a leash attachment according to this disclosure. For ease of explanation, the method 1500 of FIG. 15 is described as being performed using the leash attachment 200 of FIGS. 14A through 14D. However, the method 1500 may be used with any other suitable leash attachment, including the leash attachment 100 of FIGS. 3 through 13.

As shown in FIG. 15, the first tether 204 of the leash attachment 200 may be wrapped around a leash, harness, or other restraint device attached to an animal to provide a secure and configurable point of attachment at step 1502. To do so, a user positions the first tether 204 such that it encircles a portion of the leash or harness—such as a handle loop, strap, or D-ring—and then draws the second end of the first tether 204 toward the housing 202. The second end of the first tether 204, which terminates in the securing mechanism 208, is then coupled to a corresponding attachment point on the housing 202, forming a closed loop that securely fastens the first tether 204 around the selected portion of the animal's equipment. This method allows the leash attachment 200 to be easily and removably integrated with a wide variety of existing pet restraints without requiring permanent modification. The securing mechanism 208 is configured to resist unintentional release during use while still permitting quick detachment by the user when desired. This configuration facilitates adaptable tethering, including scenarios where the leash attachment must remain in proximity to the animal without being held, or where multiple tethering options are required during use.

The second tether 206 of the leash attachment 200 may be wrapped around an external anchor point to temporarily secure the device at step 1504. To perform this method, a user extends the second tether 206 from the housing 202 and wraps it around a fixed structure such as a post, fence, railing, table post, chair leg, backpack or other suitable anchor point. Once the second tether 206 is positioned around the anchor, the user brings the first connector 210—located at the distal end of the second tether—into engagement with the second connector 212, which is fixedly attached to the housing 202. The first connector 210 and second connector 212 are configured to securely couple to one another, forming a closed loop around the anchor point. This loop holds the leash attachment 200 in place relative to the fixed structure and thereby indirectly restrains any animal or object connected to the housing. The connection is designed to resist tension and environmental factors while remaining easily releasable by the user when detachment is desired. This method provides a quick and reliable way to temporarily secure the leash attachment 200 in a variety of settings, such as during outdoor activities, rest periods, or when temporarily tethering an animal in a safe area.

To uncouple the second tether 206 from the anchor point, the user disengages the first connector 210 from the second connector 212, thereby releasing the closed loop formed around the fixed structure at step 1506. The first connector 210, which is located at the distal end of the second tether 206, is designed for quick-release functionality and may include a push-button latch, snap-fit disengagement, or twist-to-unlock mechanism to facilitate rapid separation from the second connector 212 fixed to the housing 202. Once disconnected, the user can pull the second tether 206 away from the anchor point, fully removing the leash attachment 200 from its secured position. This operation allows for quick transition from a stationary, anchored configuration back to handheld or mobile use, enabling the user to resume movement with the attached animal or reposition the leash attachment 200 as needed. The components are constructed to ensure repeated coupling and uncoupling without degradation of mechanical integrity, making the system reliable for everyday and field use.

To retract the second tether 206, the user actuates the input 214, which is operatively connected to a retraction mechanism 207 housed within the housing 202 at step 1508. Upon activation, the input 214 sends a signal—either mechanical or electrical depending on the embodiment—to engage the retraction mechanism, causing the second tether 206 to be drawn partially or fully back into the housing in a controlled manner. The input 214 may be a button, switch, or touch-sensitive surface, and in some embodiments, may include tactile or visual indicators such as a click, LED, or audible feedback to confirm activation. The retraction mechanism 207 may utilize a spring-loaded spool, motorized reel, or other tension-based system to wind the second tether 206 smoothly and prevent tangling or abrupt retraction. This feature allows the user to quickly stow the tether after use—such as following disconnection from an anchor point—without manually winding or handling the full length of the tether. In embodiments where the input 214 also controls the first tether 204, the input may include a mode selector or multiple actuation zones to independently or simultaneously retract either or both tethers as needed. This automated or assisted retraction enhances convenience, reduces slack, and maintains a tidy, ready-to-use configuration for subsequent deployment.

Although FIG. 15 illustrates one example of a method 1500 for using a leash attachment, various changes may be made to FIG. 15. For example, while shown as a series of steps, various steps in FIG. 15 may overlap, occur in parallel, or occur any number of times.

What is claimed is:

1. An apparatus comprising:
a housing;
a first tether including a first end coupled to the housing;
a securing mechanism configured to removably couple a second end of the first tether to the housing;
a second tether including a first end retractably coupled to the housing;
a first connector coupled to a second end of the second tether; and
a second connector coupled to the housing and configured to removably couple to the first connector.

2. The apparatus of claim 1, further comprising:
a retraction mechanism positioned inside of the housing and coupled to the first end of the second tether.

3. The apparatus of claim 2, further comprising:
an input positioned on the housing and configured to activate the retraction mechanism to retract the second tether.

4. The apparatus of claim 3, wherein the input is activated to allow the second tether to be extended.

5. The apparatus of claim 1, wherein the securing mechanism is configured to secure the first tether to the housing at different lengths from the first end of the first tether.

6. The apparatus of claim 1, wherein the first connector is an I-bolt.

7. The apparatus of claim 6, wherein:
the second connector is a loop formed extending from the housing; and
the I-bolt is configured to connect to the loop.

8. The apparatus of claim 1, further comprising:
an accessory arranged within the housing.

9. The apparatus of claim 8, wherein the accessory is a global position positioning system (GPS) tracker.

10. The apparatus of claim 8, wherein the accessory is a storage compartment to receive animal waste bags.

11. A method comprising:
coupling a first end of a first tether to a housing;
removably coupling a second end of the first tether to the housing using a securing mechanism;
retractably coupling a first end of a second tether to the housing; and
removably couple a first connector arranged at a second end of the second tether to a second connector coupled to the housing.

12. The method of claim 11, wherein retractably coupling a first end of the second tether to the housing comprises coupling the first end of the second tether to a retraction mechanism positioned inside of the housing.

13. The method of claim 12, further comprising:
activating the retraction mechanism to retract the second tether using an input positioned on the housing.

14. The method of claim 13, wherein the input is activated to allow the second tether to be extended.

15. The method of claim 11, wherein the securing mechanism is configured to secure the first tether to the housing at different lengths from the first end of the first tether.

16. The method of claim 11, wherein the first connector is an I-bolt.

17. The method of claim 16, wherein:
the second connector is a loop formed extending from the housing; and
the I-bolt connects to the loop.

18. The method of claim 11, further comprising:
arranging an accessory within the housing.

19. The method of claim 18, wherein the accessory is a global position positioning system (GPS) tracker.

20. The method of claim 18, wherein the accessory is a storage compartment to receive animal waste bags.
